(19) United States
(12) Patent Application Publication
(10) Pub. No.: US 2006/0232030 A1
(43) Pub. Date: Oct. 19, 2006

(54) Multi-axis load rollers for an industrial vehicle

(75) Inventor: Gianni Passeri, Virgilio (MN) (IT)

Correspondence Address: MARGER JOHNSON & MCCOLLOM, P.C., 210 SW MORRISON STREET, SUITE 400, PORTLAND, OR, 97204, US

(73) Assignee: NMHG OREGON, LLC, Portland, OR (US)

(21) Appl. No.: 11/404,171

(22) Filed: Apr. 13, 2006

Related U.S. Application Data
(60) Provisional application No. 60/672,148, filed on Apr. 14, 2005.

(51) Int. Cl. B62D 21/14

(52) U.S. Cl. 280/43.12

(57) ABSTRACT

A load roller assembly includes a first load roller that rotates about a first axis, a second load roller that rotates about a second axis, and a third load roller that rotates about a third axis. The first and second load rollers are configured to move vertically up and down independently of the third load roller. This independent movement of the first and second axes provide more stable and controllable support to the front end of lift truck forks.

This application claims priority from U.S. Provisional Application 60/672,148, filed Apr. 14, 2005, and herein incorporated by reference.

### BACKGROUND OF THE INVENTION

The invention relates to a transportation device used primarily in a materials handling vehicle such as an industrial pallet truck.

Industrial pallet trucks known in the art typically include a drive or steer wheel located proximately under a vehicle frame of the pallet truck. The steer wheel may include a single tire or dual-tire construct. Two or more load wheels or load rollers are typically located near an end of the pallet truck opposite the vehicle frame, and underneath two forks. The steer wheel is used for maneuvering the pallet truck and the load rollers support the majority of the weight of a transported load carried on the pallet truck forks.

Such pallet trucks may be powered by an electric motor or may be manually pulled or pushed by an operator. Electrically powered pallet trucks may further include a platform upon which an operator may ride during transport of a load. For an electrically powered pallet truck, the steer wheel may additionally be used as the drive wheel, such that the steer wheel will also provide a traction force by which the pallet truck is caused to move.

Pallet trucks may operate in a variety of operating conditions and locations including, for example, a warehouse, a truck yard, a grocery store, a sidewalk or even an automobile road. Operating surfaces associated with these different locations also vary significantly, sometimes as a result of geography. For example, pallet trucks that operate in more rural areas may be required to traverse over unimproved or uneven surfaces such as dirt or gravel. Similarly, operating surfaces in other locations may include cobbled roads, or grooved or siped pavement.

As the pallet truck is driven by either an electric motor or by manual effort of an operator, the steer wheel and load rollers are made to rotate in the direction of vehicle travel. As the pallet truck is operated over uneven or unimproved surfaces, the steer wheel and load rollers tend to move up and down in irregular patterns causing significant vibration in the forks and vehicle frame. This vibration is transmitted through a steering handle to the operator and may result in discomfort during operation of the pallet truck. The vibrations also shake loads on the forks potentially causing the loads to become unstable or dislodged. The vibrations also create a significant amount of noise that can create a dangerous work environment or at the least be a nuisance to the operator and any bystanders. The vertical movements may also cause the load rollers to temporarily lose contact and traction with the ground making it more difficult to operate the lift truck.

The present invention addresses these and other problems associated with the prior art.

### SUMMARY OF THE INVENTION

A load roller assembly includes a first load roller that rotates about a first axis, a second load roller that rotates about a second axis, and a third load roller that rotates about a third axis. The first and second load rollers are configured to move vertically up and down independently of the third load roller. This independent movement of the first and second axes provides more stable and controllable support to the front end of lift truck forks.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is an elevated perspective view of a pallet truck having a novel load wheel assembly;

FIG. 2 is a rotated view of the pallet truck of FIG. 1 showing a bottom view of the fork with the load wheel assembly pivoted away from the fork;

FIG. 3 is an exploded and enlarged partial view of the fork and load wheel assembly shown in FIG. 1;

FIG. 4 is an enlarged view of the load wheel assembly shown in FIG. 1 mounted in a fork end; and

FIG. 5 is an elevated right side view of the load wheel assembly shown in FIG. 4.

### DETAILED DESCRIPTION

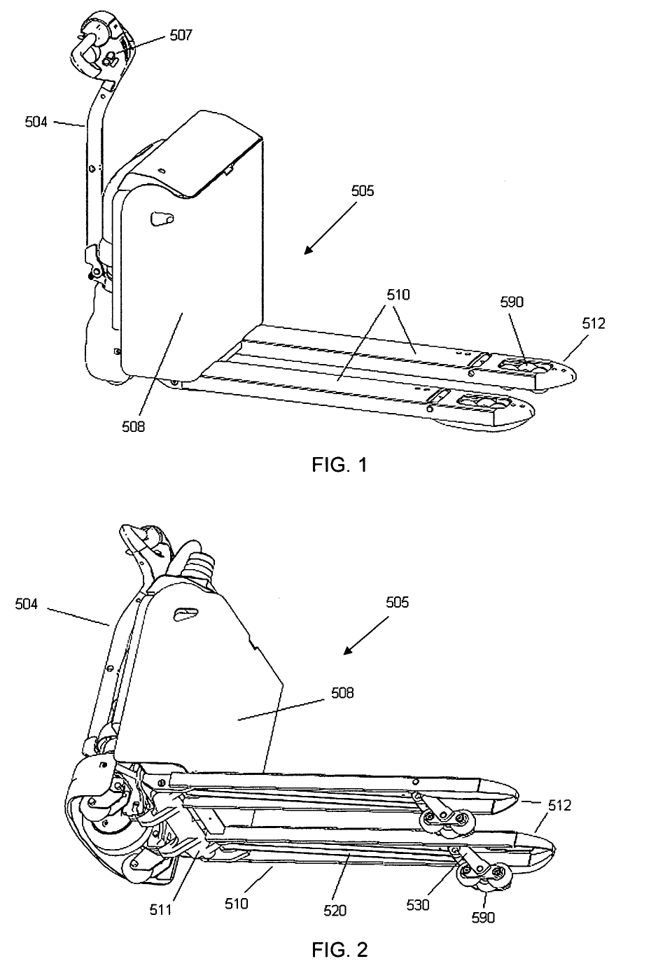

FIG. 1 shows an industrial pallet truck 5 that includes a fork 10 and a wheel assembly 590. It can be seen from FIG. 1 that the pallet truck 5 may include two forks, each nearly identical to fork 10. Furthermore, the pallet truck 5 is shown to include a vehicle frame 8 and a steer arm 4 by which the pallet truck is guided. The fork 10 is shown having a fork end 512 located on the opposite end of the fork 10 from the vehicle frame 8.

The steer arm 4 may include electronic or mechanical controls that raise and lower the fork 10 or that activate a traction motor (not shown) residing in the vehicle frame 8. It is understood that the pallet truck 5 shown is merely one example of a type of industrial lift truck that could be used with the present invention. For example, a motorized rider pallet truck may include an extended frame upon which an operator may stand while the motorized rider pallet truck is being operated. Other industrial lift trucks employing forks are similarly anticipated, and their applications and embodiments involving the present invention are herein claimed.

Pallet trucks, such as pallet truck 5, may be pulled by an operator by means of the steer arm 4, or they may be powered by the traction motor (not shown) and simply guided by the steer arm 4. In either case, the pallet truck 5 is efficient at transporting or moving a load which may be placed on one or more forks 10.

In order to efficiently transport a load, it is advantageous that pallet truck 5 include a system for raising and lowering the forks. FIG. 2 is a rotated bottom view of the pallet truck 5 shown in FIG. 1 with the load wheel assembly 590 pivoted away from the fork 10. A pivot or yoke 530 pivotally attaches the load wheel assembly 590 to the fork 10. A tension arm or push arm 520 is connected between the yoke 530 and the vehicle frame 8. The push arm 520 may be pulled rearward away from the fork end 512, for example, to lower the load wheel assembly 590, and in turn raise the fork 10. Alternatively, with the fork 10 in the raised position, the push arm 520 may be pushed forward toward the fork end 512. This raises the load wheel assembly 590 causing the fork 10 to move downward into a lowered position.

The pivoting load wheel assembly 590 allows a load to be more easily picked up, transported, and relocated with forks 10. The steer arm 4 may include a button or control switch 507 that allows the operator to raise and lower the fork 10. For example, control switch 507 may cause a mechanical, electrical, or hydraulic controlled actuator 511 to either move the push arm 520 forward or rearward. This causes the load wheel assembly 590 to pivot downward or upward, respectively, either raising or lowering the fork 10.

Pallet trucks may operate over rough pavement or other rough surfaces, such as stone or cobbled roads. The load wheels on previous pallet trucks had a tendency to bounce up and down when traversing over these rough uneven surfaces. This increased vibration and created irregular shifts in direction of the pallet truck and any load on the pallet truck. The load wheel assembly 590 shown in FIGS. 1 and 2 solve at least some of these vibration and shifting problems by maintaining more consistent contact with the traveling surface.

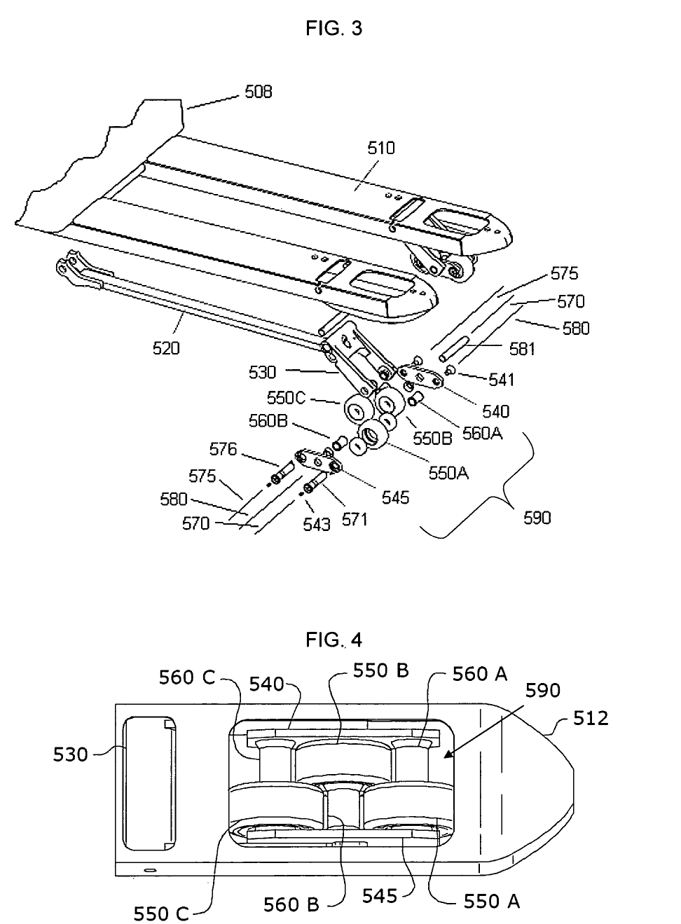

FIG. 3 provides an exploded view of the fork 10 and load wheel assembly 590 previously shown in FIGS. 1 and 2. The yoke 530 and push arm 520 of FIG. 2 are also shown partially disassembled in FIG. 3.

The load wheel assembly 590 includes three load wheels 550A, 550B, and 550C, each having a separate axis of rotation 570, 580, and 575, respectively. Axles 571, 576 and 581 are alternatively referred to as pins or rods and are each co-axially aligned with axes 570, 575 and 580, respectively. The axles each connect at opposite ends with a left mounting plate 540, a right mounting plate 545. The axles also extend through spacers 560. For example, axle 571 passes through left mounting plate 545, the front load wheel 550A, a front spacer 560, and right mounting plate 540. A cap 541 inserts into a hole (not shown) in the end of axle 571 and is held in place by a screw 543. Similar separate configurations are used to mount the middle load wheel 550B and the rear load wheel 550C.

The load wheels 550 and spacers 560 may be made out of nylon or steel. Of course other materials could also be used for spacers 560, such as other polymers, metals, or any other material known to those skilled in the art.

FIG. 4 shows an enlarged top view of the load wheel assembly 590. In one embodiment, the center load wheel 550B rotates about the axle 581 shown in FIG. 3 that extends through both wheel 550B and spacer 560B. Similarly, the front load wheel 550A rotates about the axle 571 shown in FIG. 3 that extends through both wheel 550A and spacer 560A. The rear load wheel 550C rotates about the third axle 576 in FIG. 3 that extends through both wheel 550C and spacer 560C.

The spacers 560A and 560C are located on the right sides of wheels 550A and 550C, respectively, and the spacer 560B is located on the left side of wheel 550B. The spacers 560 align the two load wheels 550A and 550C in an in-line arrangement that overlaps and is adjacent with load wheel 550B. This parallel overlapping alignment reduces friction, noise, and vibration as will be described in more detail below. The center load wheel 550B is alternatively referred to as a load roller.

The three load wheels 550 provide three points of contact with the ground that conform with changes in the ground terrain. This allows the load wheels 550 to maintain more consistent contact with varying ground terrain thus reducing friction, vibration and resulting noise in the forks 10. The overlapping wheel pattern helps reduce the overall dimension of the load wheel assembly 590, and allows for the load wheel assembly 90 to fit in the same shoe print as a conventional load wheel assembly. In this way, the load wheel assembly 590 may be interchangeably fitted into a conventional fork of a lift truck or pallet truck. Similarly, the three wheel overlapping design distributes the weight of loads on forks 10 across three different contact points. This further reduces deflection, stress and wear to each of the individual load wheels 550.

It is noted that although the drawings show the load wheel assembly 590 having load wheels 550, it is similarly anticipated that the load wheels 550 could be replaced with load rollers or bearings, for example. In other words, the load wheel assembly 590 could be replaced with a load roller assembly or a load bearing assembly and these embodiments are similarly claimed herein.

### Operation

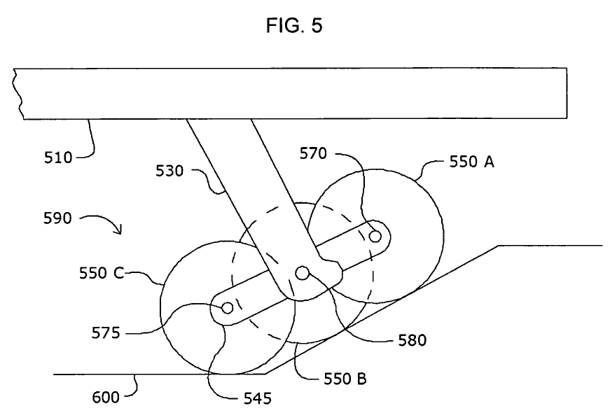

FIG. 5 shows in more detail how the load wheel assembly 590 may be operated when transporting a load on a pallet truck. The pivot or yoke 530 attaches the load wheel assembly 590 to the fork 10. The fork 10 may be lifted by pivoting the yoke 530 downwards towards a traveling surface 600 or lowered by pivoting the yoke 530 upwards. The load wheel assembly 590 includes a left plate 540 and right plate 545, that articulate about the central axis 580. The wheel 550B also rotates about axis 580 and front and rear wheels 550A and 550B rotate about axes 570 and 575, respectively.

As the load wheel assembly 590 approaches a non-planar incline in surface 600, the axis 570 for front load wheel 550A starts to move upward and rotate counter clockwise around central axis 580. Similarly, the axis 575 for rear load wheel 550C starts to rotate downward in a clockwise direction about central axis 580. When the load wheel assembly 590 moves onto level section of surface 600, axis 570 of front load wheel 550A rotates downward in a clockwise direction about central axis 580 and axis 575 of rear load wheel 550C rotates upward in a counter clockwise direction about central axis 580 until all three axes 570, 580, and 575 are substantially horizontally aligned. This rotation of axes 570 and 575 about central axis 580 allow the load wheels 550 to maintain more consistent contact against different terrain on surface 600.

Thus, a three-point contact with a non-planar traveling surface may be maintained by allowing the front and rear load wheels 550A and 550C to move in a vertical direction with respect to the central wheel 550B.

### Alternative Embodiments

In one embodiment, the front and rear wheels 550A and 550C are aligned in a linear direction that is adjacent to a path of the central wheel 550B. Additionally or alternatively, a closest distance between the front and rear wheels 550A and 550C may be less than a diameter of the central wheel 554. This overlapping arrangement further reduces the overall footprint size required for the load wheel assembly 590.

In one embodiment, the load wheel assembly 590 may only include two wheels 550. The central load wheel 550B may rotate about central axis 580 as previously shown in FIG. 3 and the front load wheel 550A rotates about the second axis 570 as also shown in FIG. 3. However, in this embodiment, there is no third load wheel 550C. In this embodiment, the axis 570 may be configured to move in a vertical direction independently of the central axis 580. In one embodiment, the front load wheel 550A may also rotate about the central axis 580. A distance between the central axis 580 and the axis 570 may be less than a diameter of either load wheel 550A or 550B.

In another embodiment, a third load wheel, such as load wheel 550C is used and arranged in the in-line orientation with the front load wheel 550A, wherein the front and rear load wheels 550A and 550C are positioned adjacent and overlapping with the central load wheel 550B.

In one three-wheel embodiment, the rear load wheel 550C may rotate about axis 575 and also rotate about the central axis 580 as shown above in FIG. 5. Advantageously, the three load wheels 55OA-550C may be arranged such that they maintain a three-point contact with non-planar traveling surfaces 600 (FIG. 5).

The load wheel assembly 590 may further be provided with spacers 560A-560C as shown in FIG. 4. Vibration and noise in the load wheel assembly 590 may be further reduced by inserting low friction spacers 560A-560C.

In another embodiment, a load roller assembly uses multiple load rollers instead of load wheels. The load roller assembly may include a first load roller that rotates about a first axis, such as the central axis 580, a second load roller that rotates about a second axis, such as the second axis 570, and a third load roller that rotates about a third axis, such as the third axis 575. The second axis 570 may be located closest to a fork end 512 and the third axis 575 may be located closest to the vehicle frame 8, for example.

In yet another embodiment, the central axis 580 is located between the second and third axes 570 and 575 and is held substantially rigid with respect to the fork 10. The second and third axes 570 and 575 may be configured to move vertically up and down independently of the central axis 580, such that the load rollers 550A and 550B (FIG. 5) can also move vertically up and down independently of the first axis 580. Additionally or alternatively, the second axis 570 may be allowed to move a vertical distance equal to and opposite that of the third axis 575.

Having described and illustrated the principles of the invention in a preferred embodiment thereof, it should be apparent that the invention may be modified in arrangement and detail without departing from such principles. I claim all modifications and variation coming within the spirit and scope of the following claims.

1. A materials handling vehicle comprising:
a fork connected to a vehicle frame; and
a load wheel assembly mounted on the fork that includes a first load wheel that rotates about a central axis and a second load wheel that rotates about a second axis configured to move independently of the central axis.

2. The materials handling vehicle of claim 1 wherein the second load wheel revolves about the central axis.

3. The materials handling vehicle of claim 1 including a third load wheel arranged in an in-line orientation with the second load wheel that is adjacent to the first load wheel.

4. The materials handling vehicle of claim 3 wherein the third load wheel rotates about a third axis parallel to and spaced apart from the central and second axis, the second and third load wheels revolving about the central axis in opposite rotational directions.

5. The materials handling vehicle of claim 3 wherein the second and third axes associated with the second and third wheel, respectively, rotate about the central axis so that the three load wheels maintain a three-point contact with a non-planar traveling surface.

6. The materials handling vehicle of claim 3 including:
a yoke coupled to the forks and having two arms;
a central axle pivotally attaching two mounting plates to the two yoke arms and rotationally coupling the central load wheel between the two mounting plates;
a front axle rotationally coupling the first load wheel between front ends of the two mounting plates; and
a rear axle rotationally coupling the third load wheel between rear ends of the two mounting plates.

7. The materials handling vehicle of claim 6 including a pivot assembly pivotally attaching the yoke to the fork so that pivoting the yoke in a first direction moves the wheel assembly downward and pivoting the yoke in a second opposite direction moves the wheel assembly in an upward direction.

8. The materials handling vehicle of claim 1 wherein a distance between the central axis and the second axis is less than a diameter of either the central load wheel or the second load wheel.

9. A load roller assembly for an industrial lift truck having a vehicle frame and two forks, the load roller assembly comprising:
a first load roller that rotates about a first forward axis closest to a front end of the forks;
a second load roller that rotates about a second rearward axis closest to the vehicle frame; and
a third load roller that rotates about a central axis located between the first and second axis.

10. The load roller assembly of claim 9 wherein the first and second load rollers are configured to move vertically up and down independently of the third load roller.

11. The load roller assembly of claim 10 including a mounting plate that articulates about the central axis and is rotationally coupled at a front end to the first load roller, at a rear end to the second load roller, and at the central axis to the third load roller.

12. The load roller assembly of claim 11 including a pivot assembly that connects the mounting plate to one of the forks, wherein the load roller assembly may be raised or lowered by pivoting the pivot assembly.

13. The assembly of claim 9 wherein the first and second load rollers are in an in-line arrangement and the third load roller is aligned parallel and adjacent to the first and second load rollers.

14. The assembly of claim 9 wherein the central axis of the third load roller is held substantially rigid with respect to the forks while the first axis for the first load roller and the second axis for the second load roller each move up and down with respect to the forks.

15. The assembly of claim 14 wherein the first and second axes rotate about the central axis in opposite directions.

16. A method for transporting goods using a pallet truck having a load wheel assembly attached to a pallet truck fork, comprising:
rotating a central wheel of the load wheel assembly about a central axis; and
rotating second and third wheels of the load wheel assembly about two associated axes configured to move up and down with respect to the central wheel.

17. The method according to claim 16 wherein the first second and third wheels maintain a three-point contact with a non-planar traveling surface.

18. The method of claim 16 including aligning the second and third wheels in a co-linear path that is offset from a path of the central wheel.

19. The method of claim 18 wherein the second and third wheels overlap with the central wheel.

20. The method of claim 16 including reducing vibration and noise of the load wheel assembly by inserting low friction spacers between the wheels and a mounting bracket.

21. The method of claim 16 including pivoting the wheel assembly with respect to a fork of the pallet truck to lower and raise the fork with respect to a traveling surface.
